(19) United States
(12) Patent Application Publication
(10) Pub. No.: US 2009/0129982 A1
(43) Pub. Date: May 21, 2009

(54) Method and Apparatus for On-Line Measurement of a Chemical Characteristic of a Chemical Process

(76) Inventor: Uri Rapoport, Moshav Ben-Shemen (IL)

Correspondence Address: LAW OFFICES OF JERRY A. SCHULMAN, 1S376 SUMMIT AVENUE, COURT C, OAKBROOK TERRACE, IL, 60181, US

(21) Appl. No.: 11/832,649

(22) Filed: Aug. 1, 2007

Related U.S. Application Data
(60) Provisional application No. 60/821,167, filed on Aug. 2, 2006.

(51) Int. Cl. G01N 27/00

(52) U.S. Cl. 422/82.01

(57) ABSTRACT

The present invention provides a method and an apparatus for performing a rapid on-line monitoring of a chemical and/or physical state such as a process stream. A process stream is transported through a chemical transport unit, based upon the request, to a reactor or processing tool. An on-line monitoring of a chemical state of the process is performed. The on-line monitoring of the process stream includes analyzing a resultant of the response of the process chemical to the apparatus enabling to determine the conductivity, permittivity and permeability of chemicals as function of frequency with or/and without an applied magnetic field. The system determines the concentrations of the chemicals from the measured function. The monitoring is utilizing the described monitoring in combination with chemometrics. In the method, for each type of analysis to be conducted, a database is provided by analyzing a series of samples using standard laboratory analytical procedures, utilizing the results as reference values to establish quantitative calibration models from the sensor using chemometric techniques and storing this information in a computer database. The data obtained from the probe is finally correlated to the reference data stored in the computer to obtain a rapid measurement of the analysis desired.

This application claims priority from U.S. Patent Application Ser. No. 60/821,167, filed Aug. 2, 2006 which is incorporated herein by reference.

This invention relates generally to analyzing reaction streams during manufacturing processes and, more particularly, to apparatus and methods for performing on-line monitoring of physical and chemical characteristics of a chemical reaction stream that can be in the form of a solution, slurry, polymer, solid or powder.

The technology explosion in the manufacturing industry has resulted in many new and innovative manufacturing processes. Some of these manufacturing processes include a large number of important steps and therefore require a number of monitoring operations to maintain proper manufacturing control. Modern industry in general and the chemical industry in particular prefer to minimize human exposure to chemicals for safety reasons and to avoid human error. Therefore on-line and in-line process monitoring and process control techniques that do not require drawing physical samples, and the ability to provide on line information to the control room and to enable either automatically or manually immediate response, is a dominant issue.

This invention relates to methods and apparatus for analyzing chemical process components, such as petrochemical distillation processes, chlorination processes, desalinization and the like. The chemical process can be in the form of solution, slurry, polymer, solid or powder.

In analytical or research activities and commercial chemical processes, there is a need for highly reliable real or near real time analysis of the chemical composition of a process.

Increasingly competitive conditions in industrial markets (e.g. food processing industry and the petroleum industry) are driving manufacturers to look for processes that will improve quality of yield, decrease production costs and decrease safety related expenses. On-line analyzers offer an attractive solution to these needs in their ability to improve efficiency and facilitate optimization of the production process while limiting errors or injuries attendant to collecting and processing test samples.

Traditionally, industries have relied on off-line analysis by drawing samples and conducting tests in a central laboratory using specialized analyzing equipment to measure physical properties such as boiling point, refractive index, viscosity, moisture content, rheologic properties. Measurement of electrochemical properties is carried out on specialized equipment used to measure conductivity, pH, redox, oxygen content, while spectrophotometric properties require the use of equipment such as X-ray analyzers, U/VIS analyzers, color analyzers, infrared (IR) analyzers, NIR analyzers, raman analyzers, chemoluminescence analyzers, NMR analyzers and chemical composition analyzers such as gas chromatographers (GC), liquid chromatographers (LC), distillation analyzers, mass spectrometers. See, for example, R. E. Sherman, L. J. Rhodes: Analytical Instrumentation Instrument Society of America).

In the last few years technologies have developed that allow on-line analysis, namely on-line NIR, on-line NMR on-line GC and the like. While there is a growing migration to on-line analysis in a variety of industries, many manufacturers still rely on sampling to control their processes.

One barrier to adopting on-line analysis is that existing on-line analyzers cannot address many industry needs due to lack of cost effectiveness or performance capabilities (e.g. need of sample preparation, need of sample clarity, need of specific equipment). Sample analysis enables the manufactures to utilize the same analyzer for a range of measurements and to avoid purchasing a number of on-line analyzers for each measurement need along the production line.

However, sampling slows down the manufacturing process. Feedback may take only a few minutes for simple measurements but may take as long as a day for more complex measurements. In many cases the manufacturing process must be stopped and cannot be adjusted until the data from the test results is received.

Inaccuracies result from the delay in measurement input and the fact that the measurement is conducted outside the reactor environment.

Sample testing typically involves complicated and expensive procedures that require experienced laboratory technicians and the purchase and maintenance of costly sample handling tools. Handling sample material outside the reactor can be hazardous and is a major concern, particularly in the chemical and petroleum industries.

The current state of the art lacks an efficient method and system for monitoring the chemical state of process streams such as slurries used in wafer-processing, or “black mixtures” in an in-line or on-line fashion. Generally, these process streams experience changes during the course of a reaction and merely performing laboratory analysis may not adequately detect these changes in time. Those skilled in the art may employ various kinds of on-line detectors, however most of them will not be effective in detecting minute chemical changes in a complex process stream.

The present invention is directed to overcoming, or at least reducing, the effects of one or more of the problems set forth above. It is desirable to provide methods and apparatus to measure quantitative and qualitative changes in a process stream that avoid the disadvantages of the prior art.

The need exists for more efficient, less expensive on-line analyzers in the industry to replace sampling and sample handling outside the reactor which is unsafe, costly and time consuming, and which leads to under-optimization of production process resulting in lower quality of yield.

In one aspect of the present invention a system for performing on-line monitoring of the chemical characteristics or properties of a process material, is provided. The present invention includes process chemical manufacturing units producing chemical process streams such as solutions, slurries, powders or the like and apparatus and methods for analyzing the process streams both on-line and in-line.

In a preferred embodiment of the invention, when a chemical process stream is transported via a chemical transport unit, on-line monitoring of a selected chemical characteristic or state of the process chemical stream is performed. The on-line monitoring of the process chemical stream includes analyzing the response of the process chemical stream to the monitoring apparatus to determine the conductivity, permittivity and/or permeability of selected process stream substituents as function of frequency with or/and without an applied magnetic field. The system determines the concentrations of the selected substituents from the measured function and determines whether the characteristics of the selected substituent are within a predetermined level of tolerance.

In yet another aspect of the present invention, a computer readable program storage device encoded with instructions is provided for performing on-line monitoring of a chemical state of a process material.

The computer readable program storage device is encoded with instructions that, when executed by a computer, performs a method, which includes receiving a request to provide a process chemical to a processing tool; transporting the process chemical through a chemical transport unit to the processing tool based upon the request; and performing an on-line monitoring of a chemical substituent of the process chemical stream. The on-line monitoring includes analyzing a signal caused by the presence of the chemicals conductivity, permittivity and permeability as function of frequency with or/and without an applied magnetic field to determine whether the characteristics of the selected substituent are within a predetermined level of tolerance.

In one embodiment, the present invention provides for determining whether a change in the chemical characteristic has occurred from a known condition to a second condition in an in-line/on-line format. Utilizing embodiments of the present invention, an on-line, real time, or a near real time assessment of the chemistry of the process chemical may be determined, thereby providing the ability to react in an instantaneous or near instantaneous fashion. Embodiments of the present invention provide for measuring conductivity (σ), permittivity (ε), and permeability (μ) as a function of frequency (f), and as a function of an applied magnetic field (B₀) apparatus. The system determines the concentrations of the chemicals from the measured functions.

Further embodiments of the present invention provide for a substantially real time analysis of the process stream. Embodiments of the present invention provide for a method and apparatus for performing a feedback correction directed to modifying the nature of the slurry to have physical characteristics that are generally within predetermined tolerances for use in the chemical processes.

It is thus one object of the invention to provide simple, relatively inexpensive methods and apparatus for determining quantitative and qualitative changes in a chemical process stream.

It is another object of the invention to provide such methods and apparatus adaptable for use in an industrial environment.

It is yet another object of the invention to provide such methods and apparatus that are adaptable for use in non-invasive on-line process analysis.

It is still another object of the invention to provide such methods and apparatus that are adaptable for use in non-invasive in-line process analysis.

### BRIEF DESCRIPTION OF THE DRAWINGS

Other objects of the invention will become apparent from the following description and the accompanying drawings, in which:

FIG. 1 is a schematic diagram of a probe constructed in accordance with a preferred embodiment of the present invention;

FIG. 2 is a schematic diagram of the probe of FIG. 1 in a circuit;

FIG. 3 is a schematic diagram of another preferred embodiment of the present invention;

FIG. 4 is a partial sectional elevation showing use of the present invention in an on-line configuration;

FIG. 5 is partial sectional elevation showing use of the present invention in an in-line configuration;

FIG. 6 is a schematic view of a preferred embodiment showing use of a probe with an applied magnetic field;

FIG. 7 is a schematic view of a preferred embodiment showing use of a probe with an applied magnetic field together with a probe used without a magnetic field; and

FIG. 8 is a representative graph showing salinity data gathered using the present invention.

### DETAILED DESCRIPTION OF THE INVENTION

While the following describes a preferred embodiment or embodiments of the present invention, it is to be understood that this description is made by way of example only and is not intended to limit the scope of the present invention. It is expected that alterations and further modifications, as well as other and further applications of the principles of the present invention will occur to others skilled in the art to which the invention relates and, while differing from the foregoing, remain within the spirit and scope of the invention as herein described and claimed. Where means-plus-function clauses are used in the claims such language is intended to cover the structures described herein as performing the recited functions and not only structural equivalents but equivalent structures as well. For the purposes of the present disclosure, two structures that perform the same function within an environment described above may be equivalent structures

In one aspect of the present invention, a data collection and transmission system is provided to perform on-line or in-line monitoring of a chemical state of a process reaction stream. The system measures the conductivity (σ), permittivity (ε), and permeability (μ) of the stream's chemical substituents as a function of frequency (f), and as a function of an applied magnetic field (B₀). The system determines the concentrations of the chemicals from the measured functions.

A preferred embodiment of the system uses a probe consisting of a coil or coils that encircle or are immersed in a tube, pipe, container or a canister that contain the chemical(s) to be analyzed. Another embodiment of the probe consists of two or more conductive electrodes where the chemicals to be analyzed are located in a lumen between them. The probe has an impedance (Z) which is a function of the frequency, chemical concentrations, temperature (T), and the applied magnetic field B₀.

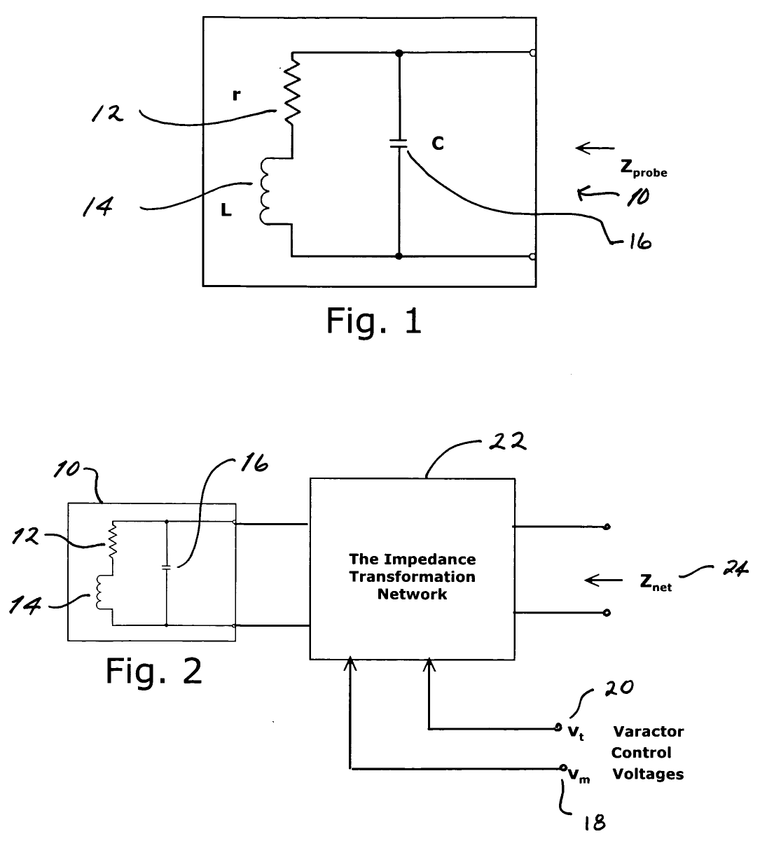

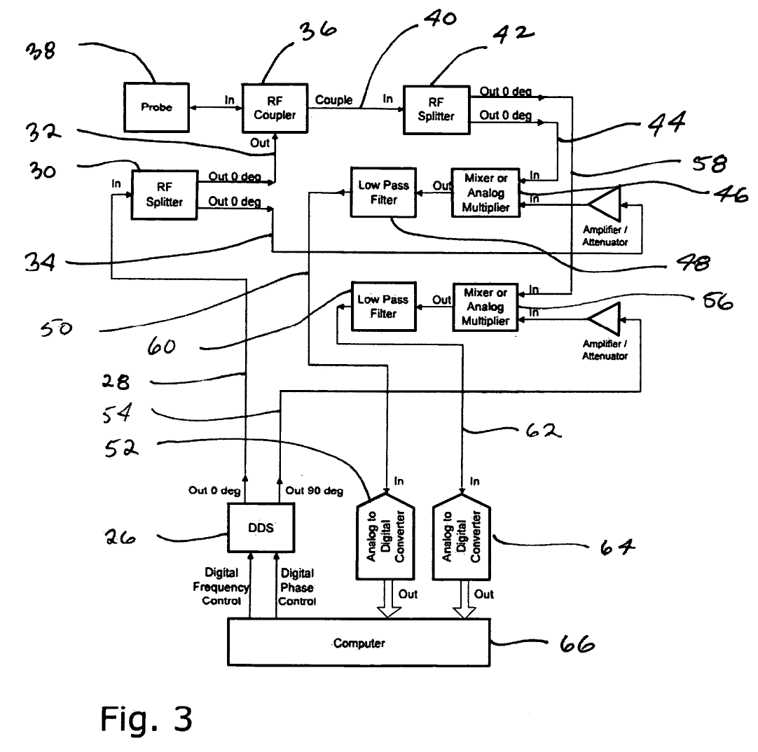

For each frequency and amplitude of applied magnetic field, and for a given chemical's concentration and temperature, the impedance is composed of an inductance in series with a resistance, all in parallel with a capacitance. The probe's impedance can be regarded conceptually as comprised of inductances (L), resistances (R), and capacitances (C). As thus seen in FIG. 1, operatively probe 10 consists of a resistor 12 in series with an inductor 14, with capacitor 16 in parallel with resistor 12 and inductor 14.

Two methods are disclosed to measure impedance as a function of frequency. The first is referred to as the “Tune to Z₀” method.

As seen in FIG. 2, the Tune to Z₀ method uses two variable capacitors (varactors) 18, 20 attached to the probe in such a way as to implement an impedance transformation network 22 that is capable of transforming the probe's impedance (Z_{probe}) 24 to a pre-defined impedance Z₀. A preferred value of Z₀ is 50Ω.

A feedback control loop modifies two control voltages (Vₜ and Vₘ) that are supplied to varactors 20, 18 as part of the transformation network 22, until the transformed probe's impedance 24(Zₙₑₜ) approaches Z₀. The values of the two control voltages that caused Zₙₑₜ to become Z₀ will be recorded in a computer used to store such values, and are unique to the un-transformed probe's impedance Z_{probe}.

It is easier and cheaper to determine how close impedance is to a given value such as 50Ω than to measure an arbitrary impedance. One of the preferred ways of determining the difference of a given impedance from 50Ω is to inject an RF CW signal (a signal of single frequency and constant amplitude) from a 50Ω source into that impedance, and to measure the amplitude of the returned signal. The higher the amplitude of the returned signal, the further is the value of the given impedance from 50Ω. At 50Ω there will be little if no returned signal. Therefore, there is no need for a vector measurement system to measure both amplitude and phase.

The transformed probe is connected to the main system via a coaxial cable of impedance 50Ω, and two cables that pass the control voltages (Vₜ and Vₘ) from the main system to the probe. The complexity of the probe assembly is minimal, as it comprises of the coil and the transformation network, and does not have to contain an impedance measurement system or devices such as amplifiers, RF couplers, digital to analog converters, RF mixers, or the like.

The two control voltages that transform the probe's impedance to 50Ω are determined for a series of frequencies (frequency vector), to obtain the probe impedance as a function of the frequency (the obtained values are unique to the impedance values).

The second measurement technique will be referred to as the 0° and 90° impedance measurement method.

In the 0° and 90° method, a controlled frequency and phase CW source, such as a Direct-Digital-Synthesizer (DDS) 26 is used to generate a CW signal 28 that is transmitted to an RF splitter 30. Splitter 30 produces two identical signals 32, 34 with signal 32 being transmitted to RF coupler 36 and then to a probe 38.

The returned signal 40 from probe 38 is separated from the injected signal 32 by RF coupler 36, and then is split into two identical signals using an RF 2 way splitter 42. First signal 44 is mixed with CW signal 34 using a mixer or an analog multiplier 46. A low-pass filter (LPF) 48 is located at the output of the mixer, so that only the difference of the multiplied frequencies passes. This signal 50 is then sampled using an analog to digital converter (ADC) 52.

A second DDS signal 54 is also produced which is phase shifted by 90° from signal 28. Signal 54 can be produced by DDS 26 with a relative phase shift of 90° to the original CW. A second DDS, synchronized to the first DDS can also be used to produce a CW of the same frequency but having a 90° phase shift relative to the original CW.

This 90° signal 54 is fed to another mixer or another analog multiplier 56, along with signal 58 from RF splitter 42. A low-pass filter (LPF) 60 is located at the output of t mixer 56 so that only the difference of the multiplied frequencies passes. This signal 62 is also sampled using an analog to digital converter (ADC) 64.

The two sampled signals 50, 62 are unique to the amplitude and phase of returned signal 40 from probe 38, and therefore are unique to the probe's impedance. The impedance measurement is repeated for a series of frequencies that is determined by the control software of the system computer 66, thus creating a lookup table (LTU) of the probe's impedance as a function of frequency.

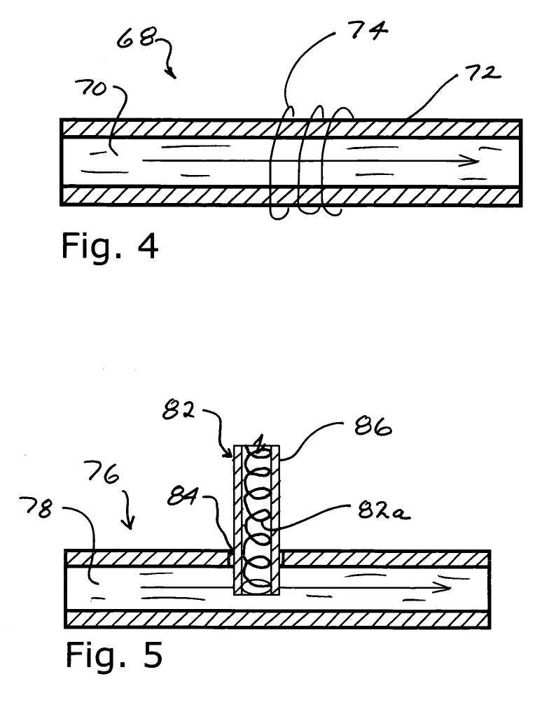

Referring now to FIG. 4, the numeral 68 identifies a preferred embodiment of the present invention used as an on-line processing system. Process fluid 70 flows as shown through process line or reactor 72 and probe 74 is formed as a loop or series of loops extending about the periphery of line 72.

Referring now to FIG. 5 the numeral 76 identifies a preferred embodiment of the present invention used as an in-line processing system. Process fluid 78 flows as shown through process line or reactor 80 and probe 82 is formed as a loop or series of loops and extends into line 80 through port 84. A protective sheath 86, formed from epoxy or other protective material can be used to embed probe 83 in those instances where the process fluid may damage the material from which probe 82 is formed.

In another preferred embodiment of the invention a probe is disposed in operative relation to a magnet assembly which applies a known magnetic field to the sample. Such an arrangement is described in U.S. Pat. No. 5,978,694.

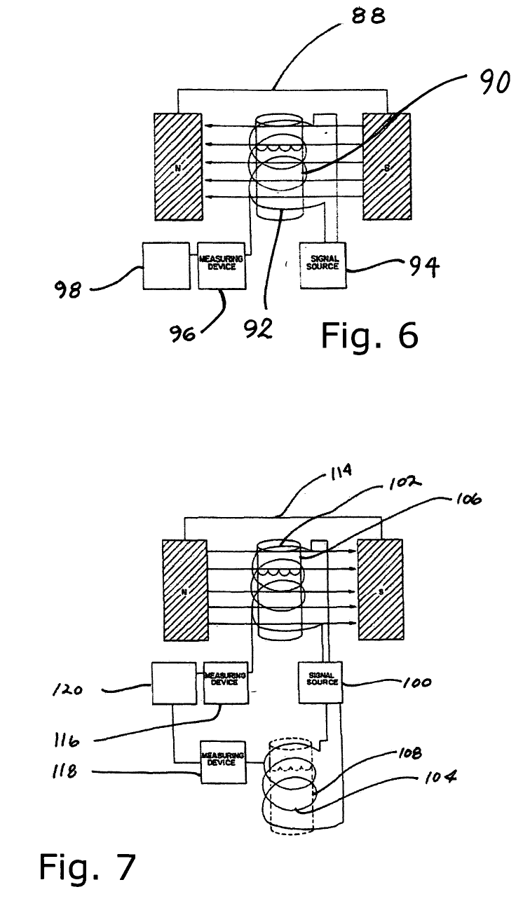

As seen in FIG. 6, magnet assembly 88 is positioned to apply a magnetic field to chemical process stream 90, flowing through conduit segment 92. Magnet assembly 88 preferably will be positioned to apply the magnetic field in a direction relative to the orientation of stream 90 to optimize the effect on the substance of interest in stream 90 as detected by conductor or probe 92. A signal source 94 provides the selected signal pulses to probe 92 and the return signal is received and interpreted by measuring device 96, the output of which is then sent to computer 98.

The chosen applied magnetic field direction can be fixed or variable. The intensity and the gradient of the applied magnetic field can also be fixed or variable, depending on the particular application of the invention.

In this manner, the inventive method and apparatus can be used to monitor the progress of a chemical reaction or physical change in the process.

As an example without limitation, the invention can be used to monitor the physical changes that occur in the hardening of a resin containing a substance such as a paramagnetic material, the polarization response of which to an applied magnetic field changes as the resin changes from a liquid state to a solid state.

Similarly, the invention can be used to monitor the progress of a chemical reaction if the reaction either produces or consumes a substance measurably responsive to the applied magnetic field. As an example, if a chemical reaction either produces or consumes a paramagnetic ion, then the change in the concentration of that paramagnetic ion as the reaction proceeds will cause a change in the total magnetic susceptibility of the sample, and thereby cause a change in the performance characteristic of the probe as measured by the measuring device. Even if the reaction under direct study does not produce or consume a paramagnetic ion, the sample can be “spiked,” either with a paramagnetic ion that is consumed by one of the reaction products, or with a substance that reacts with one of the reaction products to produce a paramagnetic ion. In this way, the production or consumption of paramagnetic ions will cause a change in total magnetic susceptibility of the sample, measurable as a change in a performance characteristic of the probe, to allow indirect monitoring of the principal chemical reaction under consideration.

Another example of this embodiment is illustrated schematically in FIG. 7, in which the apparatus of FIG. 6 is modified by adding a second probe or electrical conductor.

A single signal source 100 is used to supply an electromagnetic signal to first probe 102 and second probe 104, with probe 102 positioned at conduit segment 106 and second probe 104 positioned around conduit segment 108. Ideally the two probes 102, 104 have identical electrical performance characteristics of resistance, capacitance, conductance, inductance, efficiency, and the like. In the embodiment shown, conduit segment 106 is positioned within magnet assembly 114 in the same manner as described in connection with the embodiment shown in FIG. 6, while conduit segment 108 is not subjected to any applied magnetic field.

The return signal from probe 102 is received by measuring device 116, while the return signal from second probe 104 is received by measuring device 118. Both are then output to computer 120 for analysis.

Performance characteristics of each probe can be pre-determined and the data stored in a computer. The difference in the value of the selected performance characteristic of the probes, as measured by measuring device will be a function of the magnetic susceptibility of the solution. Computer 118 then determines the difference between the performance of probe 102 with the sample in the presence of the magnetic field, and the performance of probe 104 with the sample in the absence of the magnetic field. The difference between the two values, corrected for inherent differences in the performance values of the two probes, will be a function of the magnetic susceptibility of the chemical process stream. By subtracting out the effects not due to the applied magnetic field, it is possible to determine the quantity of material in the process stream responsive to the applied magnetic field.

Depending on the particular application intended for the device, each probe may be in any desired configuration such as a coil, a wire, or a plate. A probe performance characteristic is measured by known techniques and “performance characteristics” include, without limitation, such properties as conductivity (σ), permittivity (ε), and permeability (μ) as a, function of frequency (f), and as a function of an applied magnetic field (B₀). The system determines the concentrations of the chemicals from the measured functions.

The chemical transport conduit may comprise various mechanical and electrical devices designed to generate pressure and/or other stimuli to transport the chemical process stream from a process chemical unit to the processing tools or reactors. The chemical transport conduit may include various sensors that provide data to a chemical analysis unit. The chemical analysis unit is capable of analyzing data from various sensors in an on-line or in-line and/or an off-line manner. The chemical analysis unit is also capable of providing feedback signals to affect the chemical characteristics of the process stream in the reaction vessel.

The chemical analysis unit may also comprise a temperature sensor that is capable of sensing the temperature of the process chemical in the chemical transport conduit. Data from the temperature sensor may also be analyzed by the computer system. This analysis may be used to affect and/or calibrate the sensor, The results from the sensor may be adjusted or calibrated based upon the temperature detected by the temperature sensor. The chemical analysis unit is capable of determining the process chemical in the chemical transport conduit and making a determination as to the chemical state of the process chemical stream. Based upon the characterization of the chemical state of the stream in the chemical transport conduit, the computer system may perform various resulting tasks, such as stop the flow of the chemical transport conduit, affect the chemical characteristic of the process chemical in the chemical transport conduit, and the like.

The chemical analysis unit may be capable of correlating changes in concentration of particular chemicals (e.g., such as hydrogen peroxide concentration) in the process chemical in the chemical transport conduit, to Impedance measurement. The chemical analysis unit may be capable of performing a linear correlation between the Impedance measurement and the percentage of a particular chemical, e.g., hydrogen peroxide, glycol, and the like, in the process chemical or slurry in the chemical transport conduit. The measurement of the chemical transport conduit may be performed on a portion of the chemical transport conduit (e.g., a slip stream) that may be narrower than other portions of the chemical transport conduit.

The sensor may also comprise one or more flow cells. The flow cells are provided for facilitating flow of process chemicals (e.g., slurry or liquid) through the sensor. The flow cells may provide a continuous liquid flow of the process chemical through the sensor for more accurate sensing. The chemical analysis unit may then adjust the signal to compensate for various factors, such as the temperature detected by the temperature sensor. The temperature may affect the quantification of the Impedance measurement. Therefore, an adjustment to the signal based upon the temperature may be performed to calibrate the signal.

In one embodiment, an apparatus may be provided to direct the process chemical in the chemical transport conduit to the Impedance sensor. For example a slip stream, which may be placed at various locations on the chemical transport conduit, provides for directing a portion of the process chemical in the chemical transport conduit to be sent to the sensor. A line routes process chemicals or slurry from the chemical transport conduit to the slip stream. The control unit may control the operation of the slip stream. In yet another embodiment The sensor can be placed directly on a chemical transport conduit already exist in the process vessels.

Table 1 illustrates the wide variety of chemical concentrations determinable through the use of the present invention but it is by no means a limitation of the invention.

TABLE 1

| Active chemical in sample | | |
|---|---|---|
| stream | reagent | Reaction/product |
| NaOH | Water | dilution |
| HCl | Water | dilution |
| CH3CH2OH (Ethanol) | Water | dilution |
| NaCl | Water | dilution |
| NaOH (water) | HCl | NaCl/titration |
| NaOH (water) | Cl2 (gas) | NaOCl |
| NaCl | Milk | dilution |
| NaCl | Cheese | salinity |
| n-Hexane | Petroleum ether | distilation |
| Isophtalic acid | Nitric acid | 5-nitoisophthalic |
| | | acid/nitration |
| Mg(OH)2 (powder) | Water | Humidity measurement |
| FeCl2 | Water | Fe(OH)3 + dilution |
| Crude oil | Cracking/ | petrol |
| | distilation | |
| PBBMA | PBBPA | Polymerization |
| NaCl or NaOCl or Ethanol | water | Temperature change |
| PIREX | air | Glass (solid) width |
| Vax | temperature | Viscosity change |

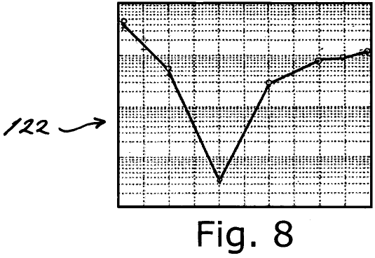

FIG. 8 depicts a graph 122 showing data gathered for concentration of sodium chloride in which the parameter of the solution (salinity) to be determined is measured by maximum correlation between a line parallel to the frequency axis on the surface of the data (the surface can be row data or parametric surface that fit the row data) and the result of measurement of current values as function of frequency. The correlation calculated for real part of the measurement imaginary part and on the complex surface.

A measuring probe equipped with a Hewlett-Packard network analyzer was calibrated to 50 and adjusted to a resonance frequency of 58 MHz for a given solution salinity concentration. A Smith chart was measured for a set of tubes, and only the measurement on the resonant frequency was recorded.

The following parameters were recorded: •Real and imaginary part of the load• The equivalent electric circuit parameter (Impedance. inductance and capacitance).

Two sets of experiments were conducted i.e. one for concentrations of between 5000 to 10000 milligram/litre the second for concentrations of 50 to 3000 milligram/litre. The significant parameter shown is the effective impedance.

As seen in FIG. 8, the effective impedance increases monotonically and close to the calibrated concentration the measurements are while very far from the calibrated concentration, the impedance reaches a limiting value and changes very slowly as a function of the concentration. At the limiting value, the impedance reaches saturation. Between these two limiting concentrations, saturation on one end and the calibration concentration on the other end, the measurements are stable and the changes of the values measured, as function of concentration change, is substantial.

This data is stored in a database and is used as a lookup table (LUT) for the same combination of probes and process liquid to correlate probe performance with salinity.

Another application example of this invention is the on-line monitoring of the production of sodium hypochlorite (reaction course between NaOH and Cl2). Such a control provides the manufacturer with the ability to control the reaction course, the end point and the product's specification. This provides the manufacturer method for controlling a robust process with a consistent product specification over time.

What is claimed is:

1. Apparatus for monitoring a process liquid while in a reaction vessel or conduit, said apparatus comprising:
means for measuring selected chemical characteristics of said process liquid,
said measuring means including at least one probe located proximate said vessel or conduit;
said producing an RF signal into and across said process liquid;
means for detecting and measuring said RF signal;
means for correlating said. RF signal to known physical and chemical characteristics of said process liquid,
said correlation means including one or more lookup tables of information listing measured of said process liquid at predetermined RF signal responses; and
means for displaying the concentrations of the constituents of said process liquid as a function of said signal correlation to said lookup table.
